(19) United States
(12) Patent Application Publication
(10) Pub. No.: US 2006/0234179 A1
(43) Pub. Date: Oct. 19, 2006

(54) Dental aligner devices having snap-on connectors

(76) Inventors: Huafeng Wen, Redwood City, CA (US); Frank Zhenhuan Liu, Redwood City, CA (US)

Correspondence Address: MORRISON & FOERSTER LLP, 755 PAGE MILL RD, PALO ALTO, CA, 94304-1018, US

(21) Appl. No.: 11/107,584

(22) Filed: Apr. 15, 2005

(51) Int. Cl. A61C 3/00

(52) U.S. Cl. 433/6

(57) ABSTRACT

A system for producing corrective movement in a subject's teeth includes a dental aligner device having one or more through-holes and one or more connectors fixed to the subject's teeth. The connectors can snap into the through-holes when the dental aligner is worn on the subject's teeth.

### CROSS-REFERENCES TO RELATED INVENTIONS

The present invention is related to concurrently filed U.S. Patent Application titled “Digitization of dental arch model components” by Huafeng Wen, U.S. Patent Application titled “System for registering upper and lower dental arches” by Huafeng Wen, and U.S. Patent Application titled “System for organizing dental aligners” by Huafeng Wen. Each of these applications is herein incorporated by reference in its entirety.

The present invention is also related to U.S. patent application Ser. No. 11/074,301, titled “Dental aligner for providing accurate dental treatment” by Liu et al, filed Mar. 7, 2005, U.S. patent application Ser. No. 11/074,297, titled “Producing wrinkled dental aligner for dental treatment” by Liu et al, filed Mar. 7, 2005, U.S. patent application Ser. No. 11/074,300, titled “Fluid permeable dental aligner” by Huafeng Wen, filed Mar. 7, 2005, U.S. patent application Ser. No. 11/074,298, titled “Disposable dental aligner by Huafeng Wen, filed Mar. 7, 2005, and U.S. patent application Ser. No. 11/050,051, titled “Storage system for dental devices” by Huafeng Wen, filed Feb. 3, 2005. Each of these applications is herein incorporated by reference in its entirety.

The present invention is also related to U.S. patent application Ser. No. 10/979,823, titled “Method and apparatus for manufacturing and constructing a physical dental arch model” by Huafeng Wen, filed Nov. 2, 2004, U.S. patent application Ser. No. 10/979,497, titled “Method and apparatus for manufacturing and constructing a dental aligner” by Huafeng Wen, filed Nov. 2, 2004, U.S. patent application Ser. No. 10/979,504, titled “Producing an adjustable physical dental arch model” by Huafeng Wen, filed Nov. 2, 2004, and U.S. patent application Ser. No. 10/979,824, titled “Producing a base for physical dental arch model” by Huafeng Wen, filed Nov. 2, 2004. Each of these applications is herein incorporated by reference in its entirety.

The present invention is also related to U.S. patent application Ser. No. 11/013,152, titled “A base for physical dental arch model” by Huafeng Wen, filed Dec. 14, 2004, U.S. patent application Ser. No. 11/012,924, titled “Accurately producing a base for physical dental arch model” by Huafeng Wen, filed Dec. 14, 2004, U.S. patent application Ser. No. 11/013,145, titled “Fabricating a base compatible with physical dental tooth models” by Huafeng Wen, filed Dec. 14, 2004, U.S. patent application Ser. No. 11/013,156, titled “Producing non-interfering tooth models on a base” by Huafeng Wen, filed Dec. 14, 2004, U.S. patent application Ser. No. 11/013,160, titled “System and methods for casting physical tooth model” by Huafeng Wen, filed Dec. 14, 2004, U.S. patent application Ser. No. 11/013,159, titled “Producing a base for accurately receiving dental tooth models” by Huafeng Wen, filed Dec. 14, 2004, U.S. patent application Ser. No. 11/013,157, titled “Producing accurate base for dental arch model” by Huafeng Wen, filed Dec. 14, 2004. Each of these applications is herein incorporated by reference in its entirety.

### TECHNICAL FIELD

This application generally relates to the field of dental care, and more particularly to the field of orthodontics.

### BACKGROUND

Orthodontics is the practice of manipulating a subject's teeth to provide better function and appearance. In general, brackets are bonded to a subject's teeth and coupled together with an arched wire. The combination of the brackets and wire provide a force on the teeth causing them to move. Once the teeth have moved to a desired location and are held in a place for a certain period of time, the body adapts bone and tissue to maintain the teeth in the desired location. To further assist in retaining the teeth in the desired location, a subject may be fitted with a retainer.

To achieve tooth movement, orthodontists utilize their expertise to first determine a three-dimensional mental image of the subject's physical orthodontic structure and a three-dimensional mental image of a desired physical orthodontic structure for the subject, which may be assisted through the use of x-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, the next step in the treatment (e.g., new bend in the wire, reposition or replace brackets, is head gear required, etc.), and the success of the previous step.

In general, the orthodontist makes manual adjustments to the wire and/or replaces or repositions brackets based on his or her expert opinion. Unfortunately, in the oral environment, it is difficult for a human being to accurately develop a visual three-dimensional image of an orthodontic structure due to the limitations of human sight and the physical structure of a human mouth. In addition, it is difficult (if not impossible) to accurately estimate three-dimensional wire bends (with accuracy within a few degrees) and to manually apply such bends to a wire. Further, it is difficult (or impossible) to determine an ideal bracket location to achieve the desired orthodontic structure based on the mental images. It is also extremely difficult to manually place brackets in what is estimated to be the ideal location. Accordingly, orthodontic treatment is an iterative process requiring multiple wire changes, with the success and speed of the process being dependent on the orthodontist's motor skills and diagnostic expertise. As a result of multiple wire changes, cost and subject discomfort is increased. The quality of care may also vary greatly from orthodontist to orthodontist, as does the time to treat a subject.

U.S. Pat. No. 4,793,803 by Martz discloses separate appliances insertable in and removable from the upper and lower jaws of the subject to correct minor malocclusions. Martz describes: (a) a fairly rigid portion which mates with or securely grips the tooth surface, (b) a rigid portion to provide the base and shape, and (c) an intermediate, flexible resilient portion interposed between (a) and (b) which biases the teeth into the desired position. The rigidity of the rigid portion may vary depending on the condition of an individual case. In some instances the rigid portion need only be somewhat flexible, thereby performing the function of the intermediate portion as well.

U.S. Pat. No. 6,309,215 by Phan et al. describes systems and methods for removably attaching a dental positioning appliance to the teeth of a subject during orthodontic treatment. Such removable dental positioning appliances are often preferred over conventional braces for tooth repositioning due to comfort, appearance and ease of use. These appliances apply force to specific surfaces of the teeth to cause directed movement. However, the type of movement and amount of force applied is usually dependent on the surface characteristics and positions of connection to the teeth. The appliances or connection between the appliance and the teeth may not provide sufficient anchoring to impart a desired force on the teeth to be repositioned. Thus, such systems may require the use of one or more attachment devices that may be positioned on the teeth to provide the appropriate physical features. Appliances may attached to a subject's teeth by interactions with a pit or dimple on the dental aligning devices are often not secure enough, especially when large teeth movements are required. Furthermore, over a period of usage by a subject, an aligner can also become relaxed and open up. Dental aligning devices that attach to the subject's teeth by dimples may slip over the attachment, which can result in inaccurate teeth movement and costly corrective measures in the orthodontic treatment.

However, specific design and location of these attachment devices may provide more effective repositioning forces, anchoring ability and appliance retention. The systems and methods described herein illustrate removable dental aligners having through-holes through which connectors securable to-a subject's teeth may pass and be secured. These dental aligners having through-holes may address the problems discussed above.

### SUMMARY OF THE INVENTION

Described herein are systems, methods and apparatus to correct or modify the position of a subject's teeth. Methods of manufacturing such apparatus are also described. The dental aligners described herein may be referred to as “snap-on” aligners. Implementations of the system may include one or more of the following.

Described herein are devices (e.g., snap-on dental aligners) for producing corrective movement in a subject's teeth. The devices include a dental aligner configured to be worn on a subject's teeth, and one or more through-holes passing through the device. The aligner device includes a shell portion having an outer surface and an inner surface, wherein at least a portion of the inner surface is configured to contact the subject's tooth. Thus, the thorough-holes extend from the outer surface to the inner surface of the shell portion of the dental device. The through-hole is configured to mate with a connector.

In one aspect, the present invention relates to a system for producing corrective movement in a subject's teeth. The system includes a dental aligner device having one or more through-holes, configured to be worn on the subject's teeth, and one or more connectors that are configured to be fixed to the subject's teeth. The connectors are configured to engage with the through-holes when the dental aligner is worn on the subject's teeth.

In another aspect, the present invention relates to a system for producing a snap-on dental aligner for dental treatment. This system includes a guide to indicate the location where through-holes (corresponding to connectors on the subject) are to be formed on a dental aligner, and a positioner (a positioning device) to position a hole-maker with respect to the dental aligner based on the information provided by the guide. The system also includes a hole-maker to produce through-holes in the dental aligner at the positions indicated by the guide to produce the snap-on dental aligner.

In yet another aspect, the present invention relates to a method for moving a subject's teeth in a dental treatment, comprising fabricating a dental aligner to be worn on the subject's teeth, producing one or more through-holes in the dental aligner, fixing one or more connectors on the subject's teeth to engage the through-holes, and engaging the one or more connectors on the subject's teeth with the through-holes of the dental aligner to secure the dental aligner on the subject's teeth.

Embodiments described herein may provide practical methods and systems for making dental aligners (e.g., snap-on dental aligners) and associated receiving connectors on the subject's teeth. The aligners can be attached onto the subject's teeth and assure the dental aligner to be in precise registration as designed throughout the period of wearing by the subject. The aligners may also overcome the aligner relaxation problem due to repeated uses, which is common in prior art dental aligners. The snap-on dental aligner therefore can ensure that the aligner produces the correct force to achieve a desirable movement in the subject's teeth, which improves the accuracy and effectiveness of the orthodontic treatment by the aligner.

The disclosed mechanisms in the dental aligners described include through-holes in the dental aligners and connectors fixed on a subject's teeth to receive the through-holes. The disclosed mechanisms allow the dental aligners to be effectively locked into intended positions during wearing by the subject. The registration and holding capability may thus be significantly enhanced.

The dental aligners may also lengthen the usage lifetime of an aligner by sustaining corrective forces for a longer period of time. As a result, the number of visits to the dentist office may be reduced. The material and manufacture costs of the aligners for an orthodontic treatment may be decreased. The need for corrective rework due to aligner deformation may also be significantly reduced, which may further reduce costs of the orthodontic treatment.

The snap-on dental aligners may allow a thinner dental aligner while still engaging that subject's teeth and providing sustainable forces to cause teeth movement. Thinner and lower profiled removable dental aligners are less intrusive to subject's mouth and often more comfortable for the subject to wear. Snap-on dental aligners may be applicable to class II bite corrections in dental treatment.

The properties of the snap-on aligners may also be simulated and optimized in the design process. The performance of the snap-on aligners can be optimized by varying parameters such as the number, the locations, and the density of the snap-on connectors, and the sizes and locations of the through-holes in the snap-on mechanisms, etc. The snap-on dental aligners can be manufactured by cost-effective processes such as vacuum forming, cutting by a cutter, etching by a laser beam or thermal applier, and CNC based manufacturing.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1A-1F show cross-sectional profiles of various through-holes as described herein.

FIG. 2A-2E show cross-sectional profiles of various connectors as described herein.

FIG. 3 illustrates an arrangement of fabricating a snap-on dental aligner.

FIG. 4 illustrates a system diagram for fabricating a snap-on dental aligner.

FIG. 5 is a flow chart for fabricating a set of connected dental aligners for a dental treatment in accordance with the present invention.

FIG. 6 illustrates the side view of a conventional dental aligner newly worn on a subject's tooth.

FIG. 7 shows the side view of a conventional dental aligner worn on a subject's tooth after a period of usage.

FIG. 8 illustrates the top views of a conventional dental aligner when it is newly worn and after it is worn for a period of time.

FIG. 9 illustrates a cross-sectional view of a snap-on dental aligner.

### DESCRIPTION OF INVENTION

Snap-on dental aligners are described herein. In general, snap-on dental aligners comprise dental aligners having one or more through-holes (or passages) through a wall of the dental aligner so that the dental aligner may be secured to the teeth of a user. For convenience, the snap-on dental aligners described herein may be referred to as aligners (or dental aligners). The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded a scope consistent with the appended claims.

As used herein, the term “dental aligner” refers to a dental device for rendering corrective teeth movement or for correcting malocclusion. An orthodontic treatment usually includes plurality of treatment steps. One or more dental aligners can be worn on the subject's teeth at each treatment step. The orthodontist first determines the initial configurations of the subject's teeth and decides target final configurations for the subject's teeth at the end of the treatment. One or more dental aligners can then be produced so that a subject wearing the dental aligners will gradually have his or her teeth repositioned by the dental aligner “pushing” (or pulling) against the teeth, or gums (gingiva).

As used herein a “subject” may be any subject who may benefit from the use of a snap-on aligner, including orthodontic patients.

Individual dental aligner appliances generally cover some (or all) of a subject's teeth and may extend to the gums (or other regions of the oral cavity, including the roof of the mouth). In some variations, a dental aligner may comprise a polymeric shell having a teeth-receiving cavity formed therein. The dental aligner may be formed by molding. Each individual appliance may be configured so that its tooth-receiving cavity has a geometry corresponding to an intermediate or end tooth arrangement intended for that appliance. That is, when an appliance is first worn by the subject, certain of the teeth will be misaligned relative to an un-deformed geometry of the appliance cavity. The appliance, however, is sufficiently resilient to accommodate or conform to the misaligned teeth, and may apply sufficient resilient force against such misaligned teeth to reposition the teeth to the intermediate or end arrangement desired for that treatment step. Examples of dental aligners, as well as additional description, may be found in the figures described below, as well as in the incorporated references.

The portion of the dental aligner covering the teeth may be referred to as the shell region of the dental aligner. The shell region typically has an inner (e.g., teeth-contacting) surface and an outer surface (opposite to the inner surface). The dental aligner may also be considered to have a tip region (e.g., near the crown of the teeth on which the aligner is worn) and a bottom portion, which may sit near the gums (or gingival) when the aligner is worn on the teeth. Side regions may be identified between the tip region and the bottom region (e.g., and inner side region facing the tongue, and an outer side region facing the lips).

Generally, the snap-on dental aligners described herein also comprise one or more through-holes for a connector to pass through, to secure the aligner to a subject's teeth, to help maintain the shape of the aligner, or to direct force against a subject's teeth. Various types of through-holes and connectors may be used. In addition to serving as attachment sites, through-holes may also allow the gums to “breath” by providing passages in the aligner though which gases and fluids can be exchanged.

Through-Holes

Any appropriate dental aligner may be used as a snap-on dental aligner, having one or more through-holes for mating with one or more connectors. Furthermore, the through-hole may be any appropriate through-hole that is adequate to secure the aligner to a subject's teeth, or to help maintain the shape of the aligner, or to direct forces to realign a subject's teeth. Through-holes may form passages extending the thickness of a dental aligner (e.g., from the inner surface of the dental aligner to the outer surface of the dental aligner). Through-holes may be engaged by a connector. A through-hole may also be referred to as a “window” or a passage. Thus, the through-hole forms a window or passage through the aligner, potentially providing access to the teeth and gingiva.

Any number of through-holes may be formed in an individual aligner. One or more through-holes may be used. In some variations, only one through-hole is used. In some variations, one through-hole is used per tooth covered by the aligner. The number of through-holes may be chosen or selected based on individual subject criterion (e.g., based on the force to be applied to move the teeth, the shape of the subject's teeth, and/or the arrangement of the subject's teeth). An orthodontist or other health profession may select the number of holes to be formed on an individual aligner. The number of holes may also depend upon the material used to form the aligner. More through-holes may be formed when the material is more likely to deform with use or age. In some variations, more than one through-hole may be formed for individual teeth covered by the aligner. For example, a pair of symmetrically-located through-holes may be formed on the aligner.

The number of through-holes may correspond to the number of connectors. Generally, for each connector to be attached to a subject's tooth, there is a corresponding through-hole on the subject-specific aligner. However, an aligner may have more through-holes than connectors. Thus, there may be redundant through-holes, in the event that a connector becomes disengaged, removed, or never used.

In general, through-holes may be located anywhere on the aligner. For example, through-holes may be located on the bottom region (on either or both sides of a tooth), or may be located on the sides of the aligner, or may be located on the tip region of the aligner. The location may be chosen so that the aligner applies a desired force to the subject's teeth. Thus, through-holes may be more closely located together when the aligner is more likely to slide or become dislodged because of the forces between the teeth and the aligner. Similarly, it may be beneficial to have through-holes near the ends of an aligner to aid in securing the aligner to the teeth.

Thorough-holes may be of any configuration to effectively engage connectors attached to the teeth. Thus, through-holes may have a diameter that is complementary to the shape and size of the connectors to which the aligner with mate. In some variations, the through-holes are sized differently from the connectors for ease of use. For example, all, or a portion, of a through-hole may be larger in diameter than the diameter of a connector so that the connector can easily engage the through-hole. The through-hole may have a constant diameter, or a variable diameter. In one variation, the through-hole may have a wide opening that tapers in to a smaller diameter as it passes from the inner surface to the outer surface of the aligner. In one variation, the through-hole has a larger diameter within the middle of the passage or at the outer portion of the passage. A thorough-hole may also have a smaller diameter than a connector. In some variations, when the connector engages a through-hole having a smaller diameter, the through-hole may expand, and help hold the connector engaged.

The through-hole may have any appropriate profile. For example, the cross-sectional profile (transecting between the inner and outer surfaces of the device), may be round, polygonal (e.g., triangular, square, asymmetric, etc.). In one variation, the through-hole is a slit cut through the aligner which remains closed until a connector is inserted. The longitudinal profile of the through-hole may also be any appropriate shape. For example, the longitudinal profile may conform to the longitudinal shape of the connector. Thus, if the connector has a knobbed region, the longitudinal profile may include a cavity into which the knob may fit.

The through-hole may also be formed so as to secure the connector. Thus, the through-hole may be (or may have a region that is) slightly smaller than the profile of the connector. In some variations, the through-hole has a longitudinal profile that is jagged, or edged. For example, the through-hole may have an accordion-type profile. Such edges may mate with edges on the connector. The through-hole may have directional surfaces, such as edges which point in a direction (e.g., from the inner surface to the outer surface) so that a connector may easily engage a through-hole, but less easily withdraw. In one variation, the through-hole includes a rim having a narrower diameter than a region of the connector. Thus, when the connector must “snap” past the rim within the through-hole, and may be locked into position.

An additional locking or securing device may be accommodated within the through-hole. For example, the through-hole may accommodate a pin, washer, gasket, or other locking or securing device for holding the connector within the through-hole.

The through-hole may also be reinforced. Thus, the through-hole may include additional structures to prevent damage to the through-hole, aligner or connector. For example, the through-hole may include a rim or edge where it exits the outer surface of the aligner.

As described, the through-hole may be any appropriate size. For example, the through-hole may have a diameter that is between 0.005 and 1 mm, or between 0.01 mm and 0.5 mm or between 0.1 mm and 1 mm, or between 0.001 mm and 0.1 mm.

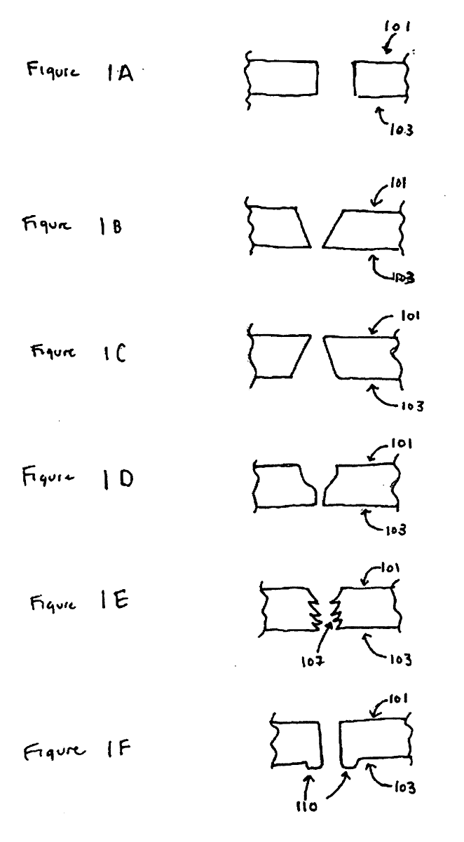

FIG. 1 illustrates additional profiles of through-holes that may be used. FIG. 1A shows a cross-section of a through-hole having a circular profile with a uniform diameter through the length of the through-hole. In all of FIGS. 1A-1F, the inner surface 101 is shown at the top of the profile and the outer surface 103 is shown at the bottom of the profile. Generally, a connector attached to a tooth enters the through-hole from the inner surface (closest to the teeth). FIG. 1B shows a through-hole that with a large opening at the inner surface 101, which gradually tapers into a narrower opening. FIG. 1C shows a through-hole with a smaller opening on the inner surface 101 that gradually enlarges to a larger opening on the outer surface 103. In FIG. 1D, the through-hole also narrows from a large opening on the inner surface 101 to a small opening in a non-linear fashion. Alternatively, the through-hole may also expand from a narrow opening to a larger opening in a non-linear way (not shown). In any of embodiment of the through-hole, the change from the outer or inner surface may be gradual, rather than sharp. For example, the edges may be rounded or smoothed, which may prevent irritation, and may aid in engaging the connector.

FIG. 1E shows one variation of a locking through-hole, having multiple ridges 107 which may engage one or more surfaces of the connector to inhibit withdrawal of the connector once it has engaged the through-hole. In FIG. 1E, the ridges 107 are directed from the inner surface 101 towards the outer surface 103. Although four ridges are shown in FIG. 1E, any number of ridges (include a single ridge) of any shape or size may be used. Furthermore, “spikes” or pins may also be used, rather than symmetric ridges (or asymmetric ridges). FIG. 1F shows a through-hole reinforced with a lip or rim 110, as described above.

The through-hole may also comprise additional materials. For example, the through-hole may be coated or lined in order to enhance the interaction (e.g., contact) with a connector, or to provide therapeutic benefit. In one variation, the through-hole is reinforced with another material (e.g., a stiff material such as a polymer, metal, ceramic, or some combination thereof). In one variation, the through-hole is coated or filled with a material to help secure the connector. For example, the through-hole may be coated with an adhesive. In one variation, the through-hole is filled with a material to maintain the shape of the through-hole until the connector is engaged with the through-hole. For example, the through-hole may have a “plug” that is pushed from the through-hole by the connector when the connector engages the through-hole. In some variations, the through-hole is coated with a lubricant.

Although FIG. 1 shows through-holes having profiles that are perpendicular to the inner and outer surfaces, the through-hole may be present in any appropriate angle to the inner and/or outer surfaces. For example, the through-hole may be angled so that the exit from the outer side of the aligner is offset from the entrance into the through-hole on the inner side of the aligner. Angled through-holes may also help secure the connector within the through-hole, and may further facilitate the application of force against the teeth by the aligner. In one variation, the through-hole is angled between about 30° and 60°. In one variation, the through-hole is angled approximately 45°.

The through-holes may also be configured to apply force to the connectors, and therefore to a tooth or teeth. For example, the walls of the through-hole may provide asymmetric force against the connector, which may in turn push or pull the tooth that the connector is attached to.

Different through-holes on the same aligner may be different shapes, sizes and/or orientations. The different shapes and sizes of the through-holes may also affect the strength of the attachment of the aligner to the teeth by the connector, as well as the force applied by the connector to a tooth. For example, through-holes located at the ends of the aligner may be configured to secure the aligner to the teeth, while through-holes located elsewhere on the aligner may be configured to help the aligner apply force to the teeth, or to a single tooth.

Connectors

Any appropriate connector may be used for connecting a snap-on aligner to a subject's teeth. Connectors are generally attached to the teeth of a subject so that the aligner may be secured to the subject's teeth by engaging the through-holes on the aligner. Typical connectors may be pre-formed (e.g., shaped before being secured to the subject's teeth) or formed at the time that they are connected to the subject. Although all of the examples described below concern connectors that are attached to the subject's teeth, connectors may be attached to any appropriate region of the subjects oral cavity, including the subject's gingiva.

A connector may be any appropriate shape for engaging with through-holes in the aligner. For example, the connector may be a post, a button, a bump, a nodule, a node, a protrusion, or the like. The connector may be shaped or sized to complement or conform to the through-holes as described above. The connector may be ridged, tubular, bulbous, or irregularly shaped. In some variations, the connector is asymmetrically shaped. In some variations, the connector comprises an orientation, so that it engages the through-hole in a particular orientation, which may prevent undesirable movement (e.g., loosening or shifting) of the connector within the through-hole. The connector may comprise any appropriate profile. For example, the cross-sectional profile may be round, polygonal (e.g., triangular, square, asymmetric, etc.), etc.

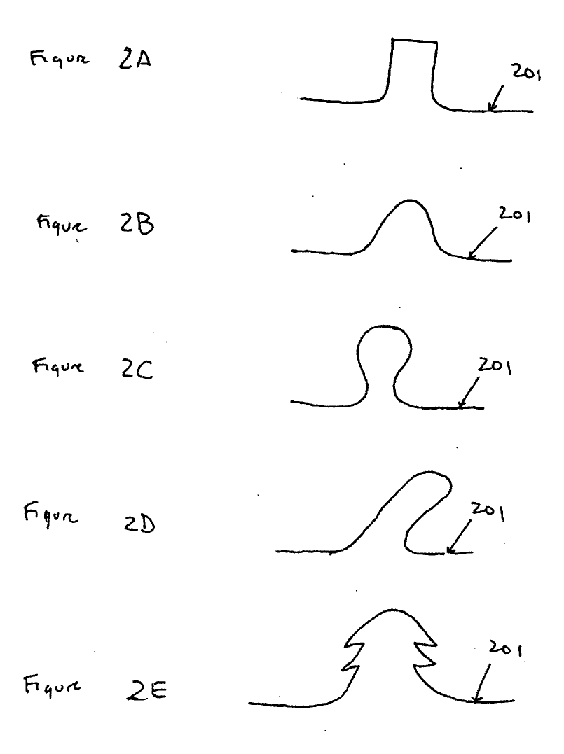

FIG. 2 illustrates profiles of different connectors. In FIG. 2A, the connector profile is a peg or box shape. In FIGS. 2A-2E the connector is shown attached to a subject's tooth 201. FIG. 2B shows a profile of a connector that is a smooth “bump” or node. The connector generally projects from the surface of the tooth, and may project far enough so that it extends beyond the outer surface of the aligner (or is flush with the outer surface of the aligner) when it is engaged with the through-hole of the aligner. In one variation, the connector extends past the outer surface of the aligner so that an edge of the connector rest on the outer edge of the aligner. In one variation, the connector does not extend out of the through-hole.

FIG. 2C shows a connector with a bulbous end (e.g., a button shaped end). The connector protrudes from the tooth on a base that is slightly narrower than the upper portion of the connector. As described for the through-holes, the connectors may also be angled in any appropriate fashion. For example, a connector may project from the surface of a tooth at a 30° angle, a 40° angle, a 45° angle, a 50° angle, a 60° angle, or an angle between 30° and 600. FIG. 2D shows a connector that is angled at approximately 45° from the surface of the tooth 201.

Connectors may be also comprise hooks, or other anchors. For example, the sides or the end of a connector may include a hook (or ridge) for securing within the through-hole of the aligner, as shown in FIG. 2E. In many instances it may be beneficial to have connectors that do not irritate or harm the subject to which the connectors are attached. Thus, the connector may be blunt (or blunted). In some variations, the end of the connector is blunt.

Connectors may also comprise additional sites for connection to anchors or to devices that may otherwise assist in moving or applying force to the teeth. For example, an elastic, rubber band, or other tensioning device may attached the connector and/or to another connector or to the aligner. A tensioning device such as an elastic band could be attached to a connector for bicuspid extraction and class II correction, for example. Thus, the tensioning device would provide additional force to move the teeth. In one variation, an anchor may also be applied to a connector after it has passed through the through-hole of the aligner to secure the aligner into position. For example, as gasket (e.g., a rubber band) may also be used as an anchor. A rubber band may be linked between two connectors on two different teeth to act both as a tensioning device (applying force to move the teeth) and as an anchor. Any appropriate anchor or tensioning device may be used.

A connector may be any appropriate size or diameter for engaging with a though-hole. For example, the connector may have a diameter that is between 0.005 and 1 mm, or between 0.01 mm and 0.5 mm or between 0.1 mm and 1 mm, or between 0.001 mm and 0.1 mm. Furthermore, any appropriate number of connectors may be used to connect to an aligner, and thus may be secured to (or fixed to) the subject's teeth. For example, the subject may have one, two, or more connectors secured to his or her teeth to engage the through-holes of an aligner.

Connectors may be positioned on the teeth in any appropriate location or locations to engage an aligner. In some variations, the location of the connectors on the subject's teeth may be determined by an orthodontist or physician. For example, the orthodontist may determine how the connectors should be located to best secure the aligner, and/or to best apply force to the teeth. The connectors may be secured to the subjects teeth before or after the through-holes have been formed in the aligner.

Any appropriate material may be used to form the connector. For example, the connector may comprise a resin, an epoxy, a cement, a polymer, a metal, a ceramic, or any combination thereof. The connector may be formed of a biocompatible material, or a bio-inert material. The connector may also comprise a material which is similar in color and/or texture to a subject's dental enamel. In one variation, the connector is secured to the subject's teeth using the same material that forms the connector itself. For example, the connector may comprise a UV cross-linkable material that may be molded into the shape of a connector and hardened (polymerized) using UV light to form the connector as part of the same step that the connector is attached to the subject's teeth. The connectors may also be attached as part of a separate step. Mechanical or chemical attachments may be used. For example, the connectors may be attached by screws, cements, etc. The shape of the connector may be adapted to help secure the connector to the teeth. For example, the connector may have a rough edge surface for bonding to the surface of a tooth.

As described above, connectors may be pre-formed, or formed at the time of attachment. In one variation, a template is used to position and form the connectors on the subject's teeth. A template may be similar to an aligner (and may be produced by a similar process, as described in the incorporated references). In one version, the template is a snap-on aligner, having through-holes. The template fits onto the patients teeth, and may include gaps or openings (negative spaces) where the connectors are to be located. The negative spaces may also be shaped like the connectors. A cross-linkable material (e.g., polymer) may be loaded into these negative spaces. The template containing the cross-linkable material may them be treated so that the material in the negative spaces is cured (cross-linked), forming the connectors, and simultaneously, bonding them to the surface of the teeth. For example, the cross-linkable material may comprise a UV cross-linkable polymer.

Making or Manufacturing a Snap-On Aligner

A snap-on aligner as described herein may be fabricated by making holes in a dental aligner that may correspond to connectors on the subject's teeth. Any appropriate method of fabricating the snap-on aligner (including making the holes) may be used.

In general, a guide is used to indicate where on an aligner the through-hole(s) should be positioned. The guide may be created by the orthodontist or doctor to indicate where to position the through-holes and/or connectors. The guide may be a manual guide (e.g., a diagram), or a computerized guide (e.g., a computer or computerized device for storing the locations). The guide may indicate the location based on a relative coordinate system. For example, the guide may indicate position based on fiduciary marks that correspond to positions of the aligner. Thus, the guide may comprise a computer to store the desired positions of the through-holes on the aligner. In some variations, the computer may be used to control the process of making the guide holes as well (e.g., by controlling a hole driller, and/or a positioner). In some variations, the computer may be used to calculate the desired number and/or position of the through-holes or connectors. computer may also be used to assist an orthodontist and/or physician in locating the through-holes and/or connectors. For example, the computer may draw, plot, or calculate the result of-different positions of through-holes/connectors on the teeth.

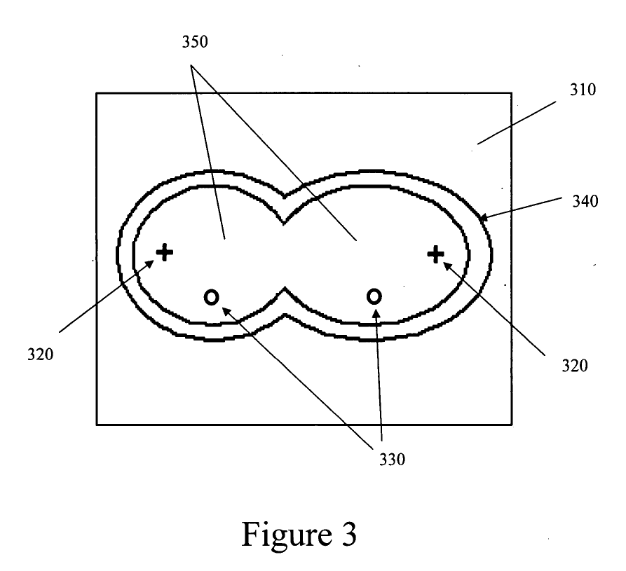

FIG. 3 illustrates an exemplified method of fabricating a snap-on dental aligner. A sheet 310 of aligner-making material is attached to a sheet holder and then lifted up near a heating element. The sheet can be made of uniform distribution of a single material or comprise multiple layers of different materials. After the aligner-making material is heated by a specified time, the sheet holder is pressed on the subject's dental arch model on the base plate. A vacuum pump removes air at the bottom of the base plate to cause the softened aligner making material to relax and fittingly form around the surface the subject's dental arch model. This process of aligner making is referred to as the vacuum forming.

In one embodiment, the subject's dental arch model includes registration marks that can be copied onto the sheet 310 of aligner-making material during vacuum forming. The copied registration marks 320 are formed on the aligner 350. A digital arch model captures the shape information of the subject's tooth models and the information about the registration marks. The digital arch model further specifies the location of the connectors to be produced on the subject teeth to receive the through-holes. A digital dental aligner model is developed based on the digital arch model for moving the subject's teeth at a particular treatment step. The digital dental aligner model specifies the locations and the sizes of the through-holes 330 in the dental aligner 350 at locations that are in registration with the connectors (e.g. protrusions 530, 540) on the subject's teeth 520.

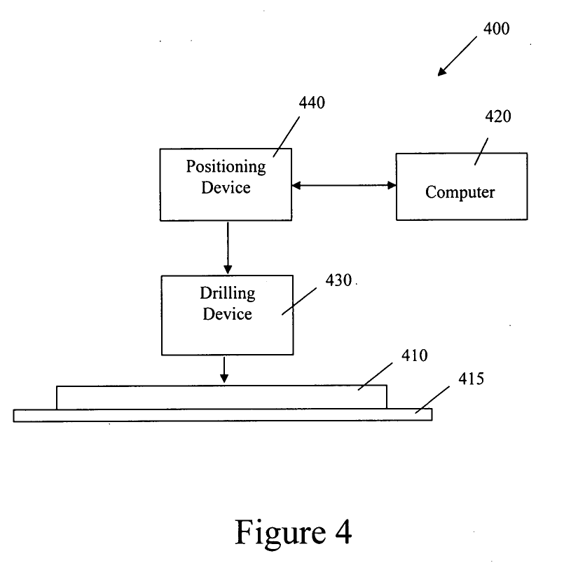

FIG. 4 shows a block diagram of a system 400 for fabricating a snap-on dental aligner. An aligner 410 is held to a stage 415. A computer 420 stores the digital aligner model and the information about the through-holes 330 to be made on the aligner 410. A drilling device 430 is mounted on a two-dimensional or three-dimensional positioning system 440. The positioning system 440 first locates the copied registration marks 320 on the sheet 310 under the control of the computer 420. The positioning system 440 defines a coordinate system in reference to the copied registration marks 320. The positional system 440 then moves the drilling device 430 to the intended locations for the through-holes 330 in accordance with the digital aligner model. The through-holes 330 can then be drilled by any appropriate method, including a mechanical drill bit or a high-power laser beam. The sheet 310 of the aligner making material is then cut out along the gingival line 340 to obtain a snap-on aligner 350 that can fit to the subject teeth.

In another embodiment, the aligner 410 is mounted on a positioner rather than the drilling device 430. The positioner is capable of producing the similar relative movement between the aligner and the drilling device 430. A coordinate system is first developed using the copied registration marks. The aligner 410 is then moved to positions to allow through-holes to be drilled at the intended locations.

In one aspect, the system 400 described above can a Computer Numerical Controlled (CNC) based manufacturing system. In still another embodiment, aligner components are fabricated by CNC based manufacturing in accordance with a digital dental aligner model. Through-holes are produced also in accordance with the digital dental aligner model. The dental aligner components are subsequently assembled to produce the snap-on dental aligner.

Using a Snap-On Dental Aligner

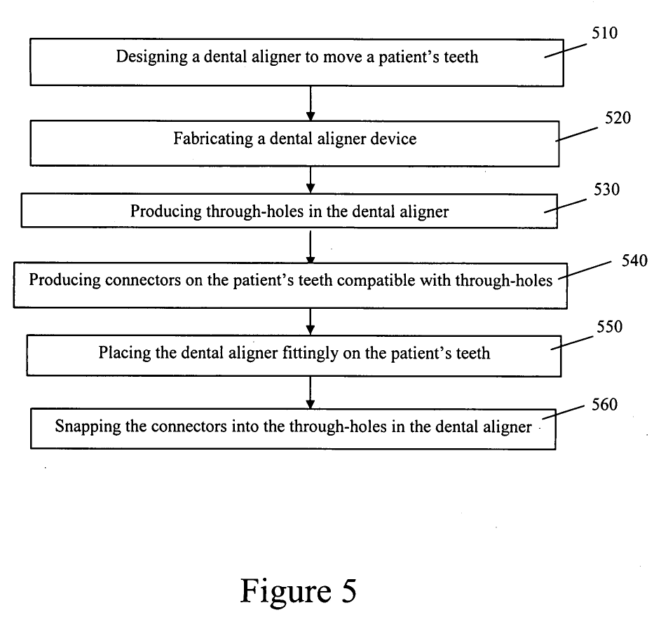

FIG. 5 illustrates an example of a process of using a snap-on dental aligner in accordance with the present invention. Dental aligners are designed for each treatment step in step 510. The dental aligner device is fabricated in step 520. The fabrication techniques can include vacuum forming, milling, stereo lithography, laser machining, molding, and so on. In accordance with the present invention, through-holes are then made in the dental aligner in the dental aligner in step 530. For example, the through-holes can be drilled with a mechanical drill bit or a laser beam. Connectors are next produced on the subject's teeth to be snapped into (e.g., engaged with) the through-holes in the dental aligner in step 540. For example, the connectors can include a pre-made component that is glued to the subject's teeth by adhesives and/or UV assisted polymerization. The dental aligner having the through-holes is then fittingly placed on the subject's teeth as described in step 550. The connectors on the subject's teeth at locations are in registration with the through-holes in the dental aligner. The dental aligner is then pressed the subject's teeth the snap the connectors into the through-holes in step 560.

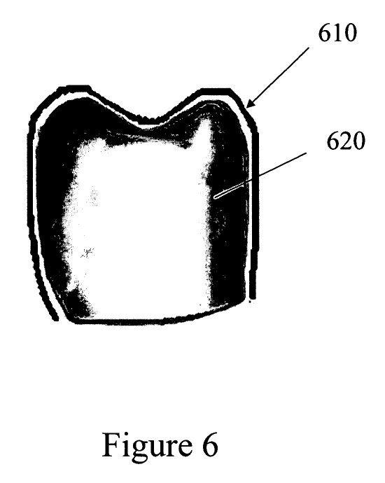

The disclosed snap-on dental aligners may help overcome the above-described aligner relaxation problem. FIG. 6 illustrates a side view of a dental aligner 610 that is newly worn on a subject's tooth 620. The aligner is typically in a shell shape, comprises a shell portion, a tip portion, and a bottom portion. The inner surface of the shell portion is to be in contact with the subject's teeth. The dental aligner 610 fits properly at the bottom of the tooth where the gingival separates the tooth from the root. The newly worn aligner 610 can provide proper and effective force for the tooth movement in the orthodontic treatment.

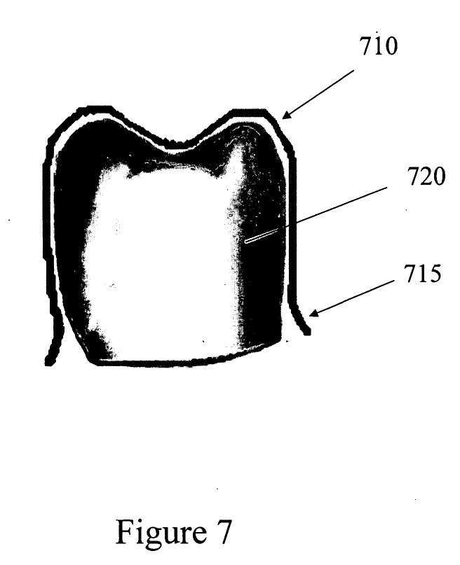

FIG. 7 shows the side view of the aligner 710 that has been worn on the subject's tooth 720 after a period of usage such as a few days or a week. The lower part 715 of the dental aligner 710 is relaxed and opened up, which prevents the dental aligner 710 to exert proper stress on the bottom of the tooth. The dental aligner 710 thus can no longer produce effective and accurate tooth movement. Different parts of the dental aligner can relax similarly to different extent.

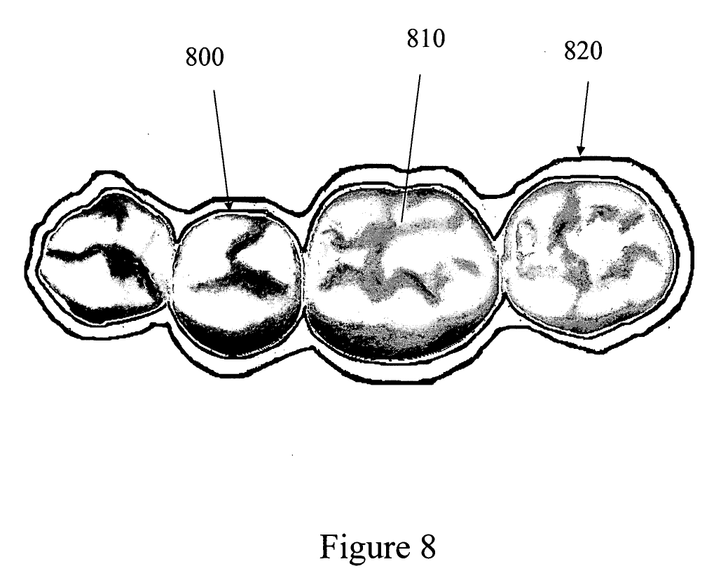

FIG. 8 illustrates the top view of a conventional dental aligner 800 that is newly worn on a subject's tooth 810. After it is worn for a period of time, the same dental aligner 820 is relaxed and loose. It can no longer apply effective forces to the tooth 810 to render tooth movement required by the treatment.

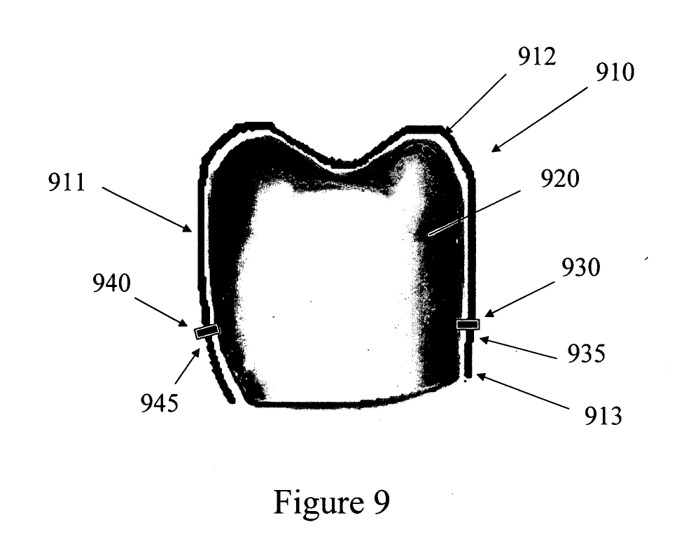

FIG. 9 illustrates a cross-sectional view of a snap-on dental aligner 910. The snap-on dental aligner 910 includes a shell portion 911, a tip portion 912, and a bottom portion 913. The snap-on dental aligner 910 also includes through-holes 935 and 945. Connectors 930 and 940 are produced on the subject's tooth 920 in registration with the through-holes 935 and-945. The connectors 930 and 940 can be formed by pre-made components glued to the subject's tooth 920 by adhesives and/or UV assisted polymerization, for example. The connectors 930 and 940 are shown as posts.

One or more connectors 930 and 940 can be fixed of a subject's tooth. Connectors 930 and 940 can be fixed to any or more than one of the shell portion 911, the tip portion 912, and the bottom portion 913. For example, connectors 930 and 940 and through-holes 935 and 945 can be produced near the bottom portion 913 to prevent the relaxation or the opening up of the dental aligner 910 near the gingival line.

The connectors 930 and 940 can be snapped into the through-holes 935 and 945 when the dental aligner 910 is pressed against the tooth 920. The dental aligner 910 is pulled toward the tooth 920 by the snap-on mechanism to come to contact with the subject's tooth 920.

The above detailed description is provided to illustrate exemplary embodiments and is not intended to be limiting. For example, any of the features of an embodiment may be combined with some or all of the features of other embodiments. It will be apparent to those skilled in the art that numerous modifications and variations within the scope of the present invention are possible. Throughout this description, particular examples have been discussed, including descriptions of how these examples may address certain disadvantages in related art. However, this discussion is not meant to restrict the various examples to methods and/or systems that actually address or solve the disadvantages. Accordingly, the present invention is defined by the appended claims and should not be limited by the description herein.

What is claimed is:

1. A device for producing corrective movement in a subject's teeth, the device comprising:
a dental aligner configured to be worn on a subject's teeth, the dental aligner comprising:
a shell portion having an outer surface and an inner surface, wherein at least a portion of the inner surface is configured to contact the subject's tooth; and
one or more through-holes passing from the outer surface to the inner surface of the shell portion of the dental device.

2. The device of claim 1, wherein the through-hole is configured to mate with a connector.

3. A system for producing corrective movement in a subject's teeth, comprising:
a dental aligner device having one or more through-holes, wherein the dental aligner device is configured to be worn on the subject's teeth; and
one or more connectors, wherein the connector is configured to engage the through-hole when the dental aligner is worn on the subject's teeth.

4. The system of claim 3, wherein the one or more connectors include one or more of posts, nodules, and bumps.

5. The system of claim 3, wherein the dental aligner contacts the subject's teeth when the connector is engaged with the through-hole in the dental aligner.

6. The system of claim 3, wherein the dental aligner is fabricated by one or more of vacuum forming, milling, stereo lithography, laser machining, molding, and CNC based manufacturing.

7. The system of claim 3, wherein the dental aligner comprises:
a shell portion having an outer surface and an inner surface to be in contact with the subject's tooth;
a bottom portion to be placed near the gingival line of the subject's tooth; and
a tip portion on the opposite side of the bottom portion.

8. The system of claim 7, wherein the through-hole of the dental aligner device passes through the bottom portion or the tip portion.

9. The system of claim 3, wherein the connector is configured to be secured to a subject's tooth.

10. A system for producing a snap-on dental aligner for dental treatment, comprising:
a guide to indicate the locations of through-holes to be formed in a dental aligner;
a positioner to position a hole-maker with respect to the dental aligner based on the indication of the guide; and
a hole-maker to produce through-holes in the dental aligner at the positions indicated by the guide to produce the snap-on dental aligner.

11. The system of claim 10, wherein the guide comprises a computer to store the locations of through-holes to be formed in a dental aligner.

12. The system of claim 11, wherein the computer is further configured to store locations of one or more connectors to be secured to the subject's teeth, so that the one or more connectors engage the through-holes when the dental aligner is worn on the subject's teeth.

13. The system of claim 10, wherein the hole-maker is configured to drill through-holes in the dental aligner.

14. The system of claim 10, wherein the hole-maker comprises a mechanical drill bit or a laser.

15. A method for moving a subject's teeth in a dental treatment, comprising:
fabricating a dental aligner to be worn on the subject's teeth;
producing one or more through-holes in the dental aligner;
fixing one or more connectors on the subject's teeth to engage the through-holes; and
engaging the one or more connectors on the subject's teeth with the through-holes of the dental aligner to secure the dental aligner on the subject's teeth.

16. The method of claims 15, further comprising fixing the one or more connectors on the subject's teeth at locations in registration with the through-holes when the dental aligner is worn on the subject's teeth.

17. The method of claim 16, wherein the connector comprises a pre-formed connector.

18. The method of claim 16, wherein the connector comprises an adhesive or a UV cross-linkable polymer.

19. The method of claim 16, wherein the one or more connectors include one or more of protrusions, nodules, and bumps.

20. The method of claim 15, further comprising securing the dental aligner against the subject's teeth to engage the connectors secured on the subject's teeth into the through-holes of the dental aligner.

21. The method of claim 15, further comprising fabricating the dental aligner device by one or more of vacuum forming, milling, stereo lithography, laser machining, and molding.

22. The method of claim 15, further comprising drilling the one or more through-holes in the dental aligners.
